(19) United States
(12) Patent Application Publication
(10) Pub. No.: US 2025/0330414 A1
(43) Pub. Date: Oct. 23, 2025

(54) NETWORK COMMUNICATION SYSTEM, COMMUNICATION DEVICE AND NETWORK COMMUNICATION METHOD

(71) Applicant: Realtek Semiconductor Corporation, Hsinchu (TW)

(72) Inventors: Yi-Ting CHIEN, Hsinchu (TW); Sung-Kao LIU, Hsinchu (TW)

(21) Appl. No.: 19/095,057

(22) Filed: Mar. 31, 2025

(30) Foreign Application Priority Data
Apr. 17, 2024 (TW) 113114387

(51) Int. Cl. H04L 43/55; H04L 43/062; H04L 49/00

(52) U.S. Cl. CPC H04L 43/55; H04L 43/062; H04L 49/3045

(57) ABSTRACT

A network communication system includes a first communication device and a second communication device. The first communication device includes a processor and a first network interface controller. The processor operates multiple virtual machines. The first network interface controller simulates a virtual network interface having a virtual network address. The first network interface controller includes a buffer for temporally storing a packet to be transmitted to the virtual machine. In response to that an available space in the buffer being insufficient, the first network interface controller generates and transmits a pause frame. The first network interface controller records the virtual network address in a source address column in the pause frame. When a second network interface controller of the second communication device receives the pause frame, the second network interface controller suspends a traffic flow to be transmitted to the virtual network address.

### CROSS-REFERENCE TO RELATED APPLICATION

This application claims priority to Taiwan Application Serial Number 113114387, filed Apr. 17, 2024, which is herein incorporated by reference in its entirety.

### BACKGROUND

### Field of Invention

This disclosure relates to a network communication system, and in particular to a network communication system performing traffic flow management for a virtual network interface.

### Description of Related Art

The traffic flow management function of network switches is used to effectively manage direction of data flow and resource allocation. The traffic flow management function is able to track and analyze network traffic, help identify bottlenecks and network problems, and avoid packet loss or transmission failure due to congestion on specific transmission paths. The traffic management function enables network switches to manage traffic more flexibly to ensure effective utilization of network resources.

### SUMMARY

An embodiment of the present disclosure discloses a network communication system including a first communication device and a second communication device. The first communication device includes a processor and a first network interface controller. The processor operates a first virtual machine. The first network interface controller simulates a first virtual network interface having a first virtual network address, the first network interface includes a first buffer for temporarily storing a packet to be transmitted to the first virtual machine. In response to a temporary phenomenon in which the first virtual machine fails to process buffer data in time, the available space of the first buffer is insufficient, the first network interface controller generates and transmits a pause frame corresponding to the first virtual network interface, the first network interface controller records the first virtual network address in a source address field of the pause frame. The second communication device includes a second network interface controller. The second network interface controller is communicatively connected with the first network interface controller. When the second network interface controller receives the pause frame, the second network interface controller suspends the packet to be transmitted to the first virtual network address.

Another embodiment of the present disclosure discloses a communication device including a processor and a network interface controller. The processor operates a first virtual machine. The network interface controller operates a physical network interface having a physical network address, the network interface controller simulates a first virtual network interface having a first virtual network address, the network interface controller includes a first buffer for temporarily storing a packet to be transmitted to the first virtual machine. In response to an available space in the first buffer being insufficient, a first virtual network interface controller generates and transmits a suspension notification to the physical network interface, the first virtual network interface records the first virtual network address in a source address field of the suspension notification. When the physical network interface of the communication device receives the suspension notification, the physical network interface suspends the packet to be transmitted the first virtual network address.

Another embodiment of present disclosure relates to a network communication method. The network communication method includes monitoring an available space of a first buffer on a first communication device, wherein the first buffer temporarily stores a packet to be transmitted to a first virtual machine on a first virtual network address; when the available space of the first buffer is insufficient, by the first communication device, generating a pause frame corresponding to the first virtual network address and recording the first virtual network address in a source address field of the pause frame; transmitting the pause frame to a second communication device by the first communication device; and according to the pause frame received, by the second communication device, suspending the packet to be transmitted to the first virtual network address.

### BRIEF DESCRIPTION OF THE DRAWINGS

FIG. 1 is a functional block diagram of a network communication system in accordance with some embodiments of the present disclosure.

FIG. 2 is a method flow diagram of a network communication method in accordance with some embodiments of the present disclosure.

FIG. 3 is a schematic diagram of a communication device in accordance with some embodiments of the present disclosure.

FIG. 4 is a method flow diagram of a network communication method in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

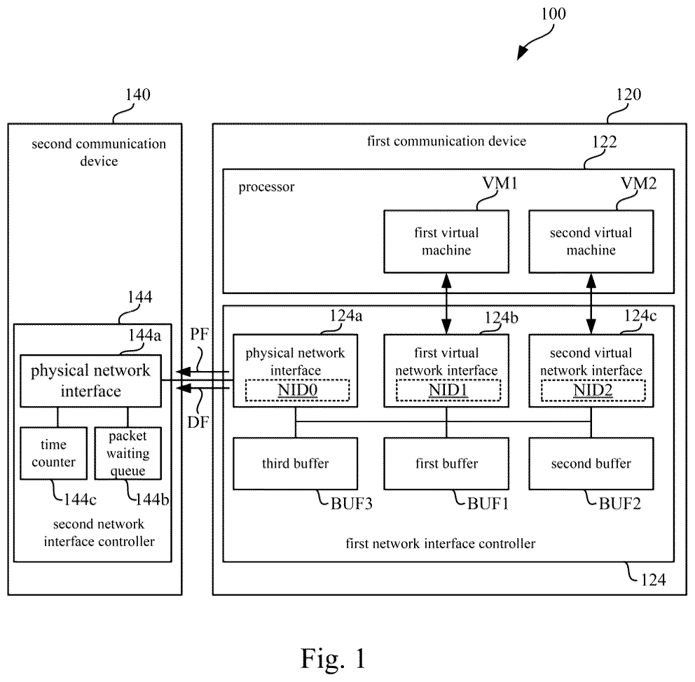

Referring to FIG. 1, FIG. 1 is a functional block diagram of a network communication system 100 in accordance with some embodiments of the present disclosure. As shown in FIG. 1, the network communication system 100 includes a first communication device 120 and a second communication device 140, and the first communication device 120 and the second communication device 140 communicatively connect with each other.

In some embodiments, the first communication device 120 may be a web server, a data server, a computing server, or any other computing devices with network communication functions. As shown in FIG. 1, the first communication device 120 includes a processor 122 and a first network interface controller (NIC) 124.

The processor 122 may include a central processing unit (CPU), a graphics processing unit (GPU), a tensor processing unit (TPU), an application specific integrated circuit (ASIC) or any other similar processors. As shown in FIG. 1, in addition to executing the operating system (not shown in the figure) inherent in the first communication device 120, the processor 122 may also operate multiple virtual machines according to actual application requirements. In the embodiment shown in FIG. 1, the processor 122 operates a first virtual machine VM1 and a second virtual machine VM2. The virtual machine may be a software-simulated computing environment that can operate multiple independent operating systems and applications on a single physical hardware. The virtual machines are used for a wide range of purposes, such as server virtualization, development and test environment establishment, application deployment, data center optimization and cloud computing. Through virtualization technology, hardware resource utilization can be improved, costs can be reduced, management can be simplified, security can be enhanced, and a flexible and rapid deployment environment can be provided.

In the embodiments of FIG. 1, the first virtual machine VM1 and the second virtual machine VM2 may simulate two computers running independently, and may have their own functions and run various operating systems, respectively. For example, the first virtual machine VM1 can run the LINUX operating system and be used as a web server, the second virtual machine VM2 can run the Windows operating system and be used as a database server. In practical applications, the processor 122 can operate even more virtual machines, which are corresponding to different application requirements, at the same time. The first virtual machine VM1 and the second virtual machine VM2 shown in FIG. 1 are for illustration, this disclosure is not limited to two virtual machines.

In an embodiment, the first network interface controller 124 may be a network interface card or a network adapter. As shown in FIG. 1, the first network interface controller 124 can operate a physical network interface 124a. The physical network interface 124a may process information transmitted externally by the processor 122 of the first communication device 120, and the physical network interface 124a may receive external information input to the first communication device 120. The physical network interface 124a has a physical network address NID0. In an embodiment, the physical network address NID0 may be a media access control (MAC) address of the first network interface controller 124. Each network interface controller or network interface card has a unique MAC address. Each set of MAC addresses in actual applications can be a unique set of 48-bit serial numbers. A specific network interface card on a wide area network (WAN) can be identified through the MAC address. The first network interface controller 124 is coupled to the processor 122.

In this embodiment, as shown in FIG. 1, in addition to the physical network interface 124a, the first network interface controller 124 may also simulate a first virtual network interface 124b and a second virtual network interface 124c. The first virtual network interface 124b is communicatively connected to the first virtual machine VM1 operated by the processor 122, the first virtual network interface 124b transmits and receives data corresponding to the first virtual machine VM1, and the first virtual network interface 124b has a first virtual network address NID1. In an embodiment, the first virtual network address NID1 of the first virtual network interface 124b may be another MAC address simulated by the first network interface controller 124, in which the another MAC address is different from the MAC address of the physical network interface 124a. In other words, the first virtual network address NID1 and the physical network address NID0 are different MAC addresses, respectively. For example, the MAC address of the physical network address NID0 may be 00:1A:4F:11:22:33, and the MAC address of the first virtual network address NID1 may be 00:1A:4F:44:55:66.

In this embodiment, the first virtual network interface 124b with the unique first virtual network address NID1 functions like an independent network interface card. If other devices in the WAN want to transmit a packet to the first virtual machine VM1, the other devices can transmit a packet to the first virtual network address NID1, and then the first network interface controller 124 transmits the packet to the first virtual machine VM1 through the first virtual network interface 124b.

As shown in FIG. 1, the first network interface controller 124 includes a first buffer BUF1. When the first network interface controller 124 receives an external packet to be transmitted to the first virtual machine VM1 through the first virtual network interface 124b, the first buffer BUF1 temporarily stores the packet to be transmitted to the first virtual machine VM1. These packets may be temporarily stored in the first buffer BUF1 until the first virtual machine VM1 confirms that these packets can be received and processed.

Similarly, the processor is further used to operate the second virtual machine VM2. The second virtual network interface 124c transmits and receives data corresponding to the second virtual machine VM2. The second virtual network address NID2 of the second virtual network interface 124c may be yet another MAC address simulated by the first network interface controller 124. The second virtual network address NID2 is different from the MAC addresses of the physical network interface 124a and the first virtual network interface 124b. For example, the MAC address of the second virtual network address NID2 may be 00:1A:4F:77:88:99. Similarly, the first network interface controller 124 includes a second buffer BUF2. When the first network interface controller 124 receives an external packet to be transmitted to the second virtual machine VM2 through the second virtual network interface 124c, the second buffer BUF2 in the first network interface controller 124 temporarily stores the packet to be transmitted to the second virtual machine VM2.

Similarly, the first network interface controller 124 includes a third buffer BUF3. When the first network interface controller 124 receives external packets to be transmitted to the processor 122 through the physical network interface 124a, the third buffer BUF3 may temporarily store these packets.

In some embodiments, the first buffer BUF1, the second buffer BUF2 and the third buffer BUF3 may be registers, cache memory, random access memory (RAM) or other memory units provided in the first network interface controller 124. In other embodiments, the first buffer BUF1, the second buffer BUF2 and the third buffer BUF3 may be part of the storage space of registers, cache memory, random access memory or other memory units in the first communication device 120, which is allocated to the first network interface controller 124.

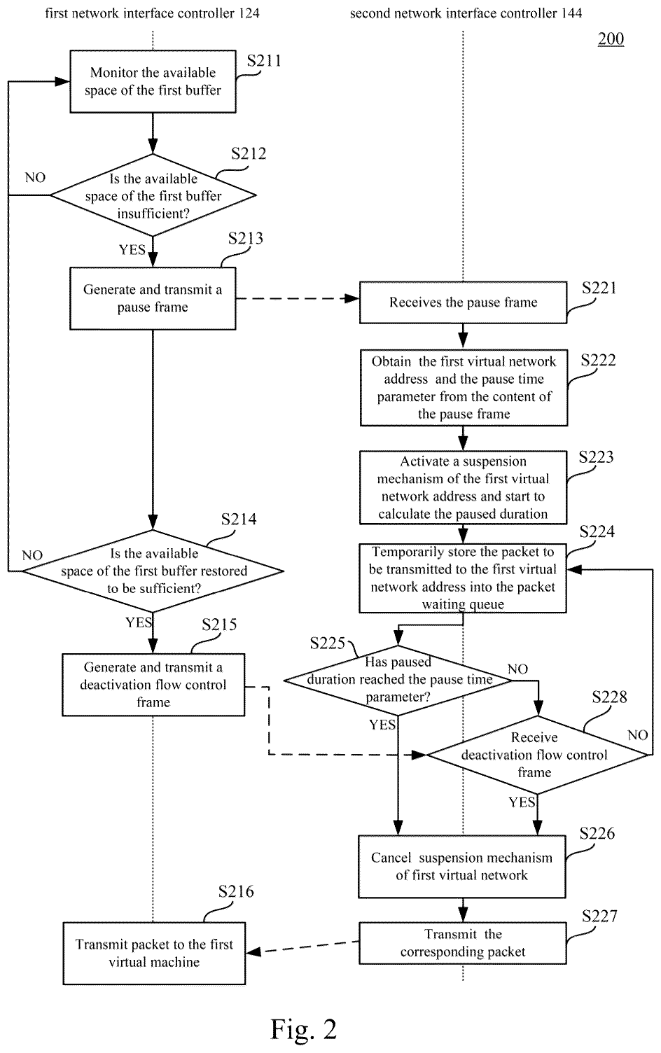

In actual circumstances, the storage spaces of the first buffer BUF1, the second buffer BUF2 and the third buffer BUF3 all have a certain upper limit. If the allocated space is too large but the utilization rate is not high, it would cause the waste of computing resources and increased manufacturing costs. In a practical example, if a large number of packets destined for the first virtual network address NID1 (that is, the packet to be transmitted to the first virtual machine VM1) are received intensively in a short period of time, this may cause the first buffer BUF1 to be completely occupied. When the available space of the first buffer BUF1 is insufficient, subsequently-transmitted packet without being well controlled may get lost. Therefore, this disclosure proposes an approach for traffic management. Please also refer to FIG. 2, FIG. 2 is a method flow diagram of a network communication method 200 in accordance with some embodiments of the present disclosure. The network communication method 200 in FIG. 2 can cooperate with the operation of the network communication system 100 in FIG. 1.

As shown in FIG. 1 and FIG. 2, in step S211 of the network communication method 200, the first network interface controller 124 of the first communication device 120 monitors the available space of the first buffer BUF1. Then, in step S212, the first network interface controller 124 determines whether the available space of the first buffer BUF1 is insufficient.

When it is found in step S212 that the available space of the first buffer BUF1 is insufficient, for example, the available space is completely occupied or is lower than a certain threshold (such as 10% of the total space), step S213 is executed. In step S213, the first network interface controller 124 generates and transmits a pause frame PF corresponding to the first virtual network interface 124b.

It should be noted that the embodiment shown in FIG. 2 takes monitoring the first buffer BUF1 corresponding to the first virtual network interface 124b as an example for simplicity and convenience of explanation. In actual circumstances, the first network interface controller 124 may also synchronously monitor the available space of the second buffer BUF2 corresponding to the second virtual network interface 124c. If the first network interface controller 124 finds that the available space of the second buffer BUF2 is insufficient, the first network interface controller 124 generates and transmits a pause frame PF corresponding to the second virtual network interface 124c, which is similar to the steps for the first virtual network interface 124b in FIG. 2. To avoid repeated description, the following embodiments will all use the first virtual network interface 124b as an example for description.

In step S213, the first network interface controller 124 records the first virtual network address NID1 in the source address field of the pause frame PF. In addition, the first network interface controller 124 records the pause time parameter (corresponding to the first virtual network address NID1) in the pause time field of the pause frame PF. In an embodiment, the pause time parameter may be a positive integer, representing the length of time that the first virtual network address NID1 is suspended from receiving a packet. For example, the pause time parameter may be set to 100, which means being suspending from receiving the packet for 100 pause quanta (i.e., 512 bit times).

In practical applications, the pause frame PF may adopt the format of Ethernet flow control. The pause frame PF may record the operation code (opcode) corresponding to the pause operation. For example, the opcode in the pause frame PF=0x0001.

As shown in FIG. 1, the first network interface controller 124 may transmit the pause frame PF recording the first virtual network address NID1 to the second communication device 140 through the physical network interface 124a. As shown in FIG. 1, the second communication device 140 includes a second network interface controller 144. The second network interface controller 144 includes a physical network interface 144a, a packet waiting queue 144b and a time counter 144c. In other words, the first network interface controller 124 may be communicatively connected with the second network interface controller 144.

As shown in FIG. 1 and FIG. 2, in step S221, the physical network interface 144a of the second network interface controller 144 receives the pause frame PF. In step S222, the second network interface controller 144 can obtain the first virtual network address NID1 and the pause time parameter from the content of the pause frame PF. In step S223, the second network interface controller 144 activates a suspension mechanism of the first virtual network address NID1, the second network interface controller 144 suspends the packet to be transmitted to the first virtual network address NID1, and the time counter 144c in the second network interface controller 144 starts to calculate the paused duration.

When the suspension mechanism of the first virtual network address NID1 is activated, the second network interface controller 144 finds all packets to be transmitted to the first virtual network address NID1. In step S224, the second network interface controller 144 temporarily stores the packet to be transmitted to the first virtual network address NID1 into the packet waiting queue 144b. That is to say, when the suspension mechanism is activated, that is, before the paused duration reaches the pause time parameter recorded in the pause frame PF, all packets to be transmitted to the first virtual network address NID1 would not be transmitted from the second communication device 140 to the first communication device 120 temporarily, but will be temporarily stored in the packet waiting queue 144b.

In an embodiment, the packet waiting queue 144b may be a register, a cache memory, a random access memory (RAM) or any other memory units provided in the second network interface controller 144 unit. In other embodiments, the packet waiting queue 144b may be a part of the storage space of a register, a cache memory, a random access memory or other memory units in the second communication device 140, which is allocated to the second network interface controller 144.

In step S225, if the second network interface controller 144 determines that the paused duration has reached (or satisfied) the pause time parameter recorded in the pause frame PF, step S226 may be executed. In step S226, the second network interface controller 144 cancels the suspension mechanism of the first virtual network address NID1.

After the suspension mechanism of the first virtual network address NID1 is canceled, step S227 may be executed. In step S227, the second network interface controller 144 may access the packet temporarily stored in the packet waiting queue 144b (that is, the packet to be transmitted to the first virtual network address NID1), and transmit the packet to the first network interface controller 124 through the physical network interface 144a. Subsequently, the packet may be transmitted to the first virtual network interface 124b through the physical network interface 124a. It should be noted that, if necessary, the packet at this time may be temporarily stored in the first buffer BUF1 corresponding to the first virtual network interface 124b. In addition, since the second network interface controller 144 may suspend the packet transmitted to the first virtual network address NID1 during the period of step S223 to step S226, it may help to relieve the congestion situation of the first buffer BUF1 (for example, in step S212, it is found that the first buffer BUF1 has insufficient available space).

In step S216, the first virtual network interface 124b in the first network interface controller 124 transmits the packet (i.e., the packet to be transmitted to the first virtual network address NID1) to the first virtual machine VM1.

It should be noted that if one of the first virtual network interface and the second network communication interface does not have a mechanism to identify and set the source address for packet distribution and suspension, the distribution and suspension operation cannot be successfully completed. If congestion occurs in one of the buffers of the first network control interface 124, the source address field recorded in the pause frame PF will be the physical network address NID0. However, such pause frame PF will cause other communication devices to suspend all packets transmitted to the first network interface controller 124. In this way, even if only the first virtual network interface 124b is congested and the second buffer BUF2 is not congested, the second buffer BUF2 will be indirectly affected, causing the second virtual machine VM2 to be unable to send and receive packets normally. In contrast, in this disclosure, the pause frame PF only suspends traffic flow for the first virtual network address NID1 and may not affect other un-suspended network addresses, such as the second virtual network address NID2 of the second virtual network interface 124c.

That is to say, even when the second network interface controller 144 receives the pause frame PF corresponding to the first virtual network address NID1 and suspends the packet to be transmitted to the first virtual network address NID1, the second network interface controller 144 may still normally transmit another packet to be transmitted to the second virtual network address NID2 to the second virtual network interface 124c of the first network interface controller 124, and then the another packet is transmitted to the second virtual machine VM2.

In this way, multiple virtual machines in the first communication device 120 may respectively transmit unique (or individual) pause frames for traffic management, and packet transmission of other virtual machines may not be suspended (or stopped) due to congestion of a single virtual machine.

In the example mentioned above, since the second network interface controller 144 determines that the paused duration has reached the pause time parameter in step S225, step S226 is executed to cancel the suspension mechanism, but this disclosure is not limited to this mentioned. As shown in FIG. 2, after the first network interface controller 124 transmits the pause frame PF, the first network interface controller 124 may execute step S214 to monitor whether the available space of the first buffer BUF1 is restored to be sufficient. When the suspension mechanism is activated (that is, before the second communication device 140 receives the deactivation flow control frame DF), the packet to be transmit to the first virtual network address NID1 would not be transmitted from the second communication device 140 to the first communication device 120 temporarily, but would be temporarily stored in the packet waiting queue 144b.

If the available space of the first buffer BUF1 is restored to be sufficient, step S215 is executed. In step S215, the first network interface controller 124 generates a deactivation flow control frame DF corresponding to the first virtual network interface 124b and transmits the deactivation flow control frame DF to the second network interface controller 144 of the second communication device 140. In step S215, the first network interface controller 124 records the first virtual network address NID1 in the source address field of the deactivation flow control frame DF, and the first network interface controller 124 records a zero value in the pause time field of the deactivation flow control frame DF. In other words, the deactivation flow control frame DF is used to set the pause time of the first virtual network address NID1 to zero.

In addition, as shown in FIG. 1 and FIG. 2, when the second network interface controller 144 determines that the paused duration has not reached the pause time parameter recorded in the pause frame PF in step S225, then step S228 is executed: In step S228, the second network interface controller 144 determines whether the deactivation flow control frame DF (generated in step S215) is received from the first virtual network address NID1. If the deactivation flow control frame DF is received, the process proceeds to step S226 to cancel the suspension mechanism of the first virtual network address NID1, and proceeds to step S227.

In the embodiments mentioned above, the network communication system 100 and the network communication method 200 are used to handle traffic management between two communication devices (the first communication device 120 and the second communication device 140), but this disclosure is not limited to these. In other embodiments, this disclosure is used for traffic management within a single communication device.

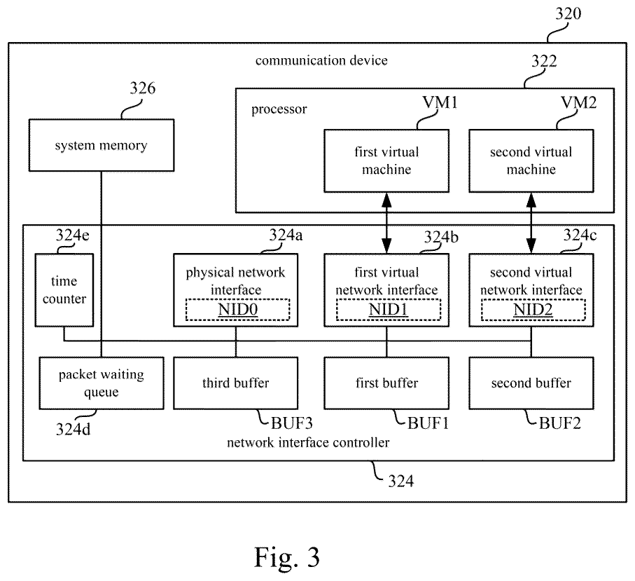

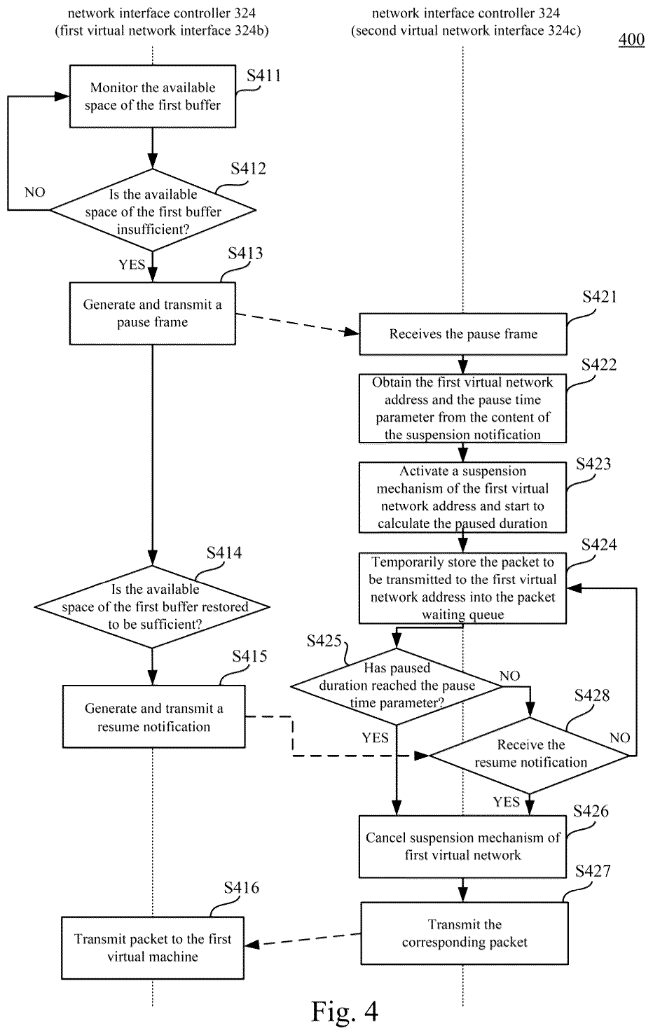

Referring to FIG. 3 and FIG. 4, FIG. 3 is a schematic diagram of a communication device 320 in accordance with some embodiments of the present disclosure, and FIG. 4 is a method flow diagram of a network communication method 400 in accordance with some embodiments of the present disclosure. The network communication method 400 in FIG. 4 may be executed by the communication device 320 in FIG. 3.

As shown in FIG. 3, the communication device 320 includes a processor 322 and a network interface controller 324. The structure and operation of the processor 322 and the network interface controller 324 in the communication device 320 are similar to the processor 122 and the first network interface controller 124 in the first communication device 120 in the embodiment of FIG. 1.

As shown in FIG. 3, in addition to executing the operating system (not shown in the figure) inherent in the communication device 320, the processor 322 may also operate multiple virtual machines according to actual application requirements. In the embodiment shown in FIG. 3, the processor 322 is used to operate the first virtual machine VM1 and the second virtual machine VM2. The processor 322, which operates the first virtual machine VM1 and the second virtual machine VM2, may simulate two computers running independently, and each of the two virtual machines has its own functions and runs various operating systems.

In an embodiment, the network interface controller 324 may be a network interface card or a network adapter. As shown in FIG. 3, the network interface controller 324 can operate a physical network interface 324a. The physical network interface 324a has the physical network address NID0. In an embodiment, the physical network address NID0 may be the MAC address of the network interface controller 324.

In this embodiment, as shown in FIG. 3, in addition to the physical network interface 324a, the network interface controller 324 also simulates the first virtual network interface 324b and the second virtual network interface 324c. The first virtual network interface 324b has a first virtual network address NID1. The first virtual network address NID1 may be a MAC address simulated by the first network interface controller 324. The second virtual network interface 324c has a second virtual network address NID2. The second virtual network interface 324c sends and receives data corresponding to the second virtual machine VM2. The second virtual network address NID2 of the second virtual network interface 324c may be another MAC address simulated by the first network interface controller 324. The first virtual network address NID1, the second virtual network address NID2 and the physical network address NID0 are respectively different MAC addresses.

The first buffer BUF1 in the first network interface controller 324 temporarily stores packets to be transmitted to the first virtual machine VM1. The second buffer BUF2 in the first network interface controller 324 temporarily stores packets to be transmitted to the second virtual machine VM2.

In this embodiment, the first virtual network interface 324b with the unique first virtual network address NID1 functions like an independent network interface card. This embodiment further describes the flow control of packet delivery between different virtual network interfaces in the network interface controller. If the second virtual machine VM2 wants to send a packet to the first virtual machine VM1, the second virtual machine VM2 may first transmit the packet to the first virtual network address NID1, and then the network interface controller 324 transmits the packet to the first virtual machine VM1 through the first virtual network interface 324b.

As shown in FIG. 3, the network interface controller 324 includes a first buffer BUF1. When the network interface controller 324 receives the packet from the external or from different virtual interfaces within the network interface controller and wants to transmit the packet to the first virtual machine VM1 through the first virtual network interface 324b, the first buffer BUF1 temporarily stores the packet to be transmitted to the first virtual machine VM1. Similarly, the network interface controller 324 includes a second buffer BUF2 corresponding to the second virtual network interface 324c and a third buffer BUF3 corresponding to the physical network interface 324a. In addition, as shown in FIG. 3, the network interface controller 324 includes a packet waiting queue 324d and a time counter 324e.

In an embodiment, the first buffer BUF1, the second buffer BUF2, the third buffer BUF3 and the packet waiting queue 324d may be a register, a cache memory, a random access memory (RAM) or other memory units provided in the network interface controller 324. In other embodiments, the first buffer BUF1, the second buffer BUF2, the third buffer BUF3 and the packet waiting queue 324d may be parts of the storage space of the registers, cache memory, random access memory or other memory units in the communication device 320, which is allocated to the network interface controller 324.

In addition, according to the actual applications, depending on waiting queue size requirements and memory area and cost considerations for network interface controller 324, the size of the waiting queue can also be expanded by allocating the protected memory on the system side of the communication device 320 as an extension of the waiting queue. In the embodiment shown in FIG. 3, the communication device 320 further includes a system memory 326, and the system memory 326 is coupled to the network interface controller 324. In some embodiments, a portion of the protected memory block in the system memory 326 may be allocated as an extension space for the packet waiting queue 324d.

As shown in FIG. 3 and FIG. 4, in step S411 of the network communication method 400, the network interface controller 324 monitors the available space of the first buffer BUF1. In step S412, the network interface controller 324 determines whether the available space of the first buffer BUF1 is insufficient.

When the network interface controller 324 finds that the available space of the first buffer BUF1 is insufficient in step S412, step S413 is executed. In step S413, the network interface controller 324 generates and transmits a suspension notification corresponding to the first virtual network interface 324b.

It should be noted that the embodiment shown in FIG. 4 takes monitoring the first buffer BUF1 corresponding to the first virtual network interface 324b as an example for simplicity and convenience of explanation. In actual circumstances, the network interface controller 324 may also synchronously monitor the available space of the second buffer BUF2 corresponding to the second virtual network interface 324c. If the network interface controller 324 finds that the available space of the second buffer BUF2 is insufficient, the network interface controller 324 may generate and transmit a suspension notification corresponding to the second virtual network interface 324c to other physical and virtual network control interfaces, which is similar to the steps for the first virtual network interface 324b in FIG. 4. In actual circumstances, when the first virtual network interface 324b transmits a suspension notification (or resume notification), the physical network interface in the network interface controller 324 and other virtual network interfaces will receive the suspension notification (or resume notification). In order to avoid repeated description, in subsequent embodiments, the first virtual network interface 324b is used as the transmitter of the suspension notification and the second virtual network interface 324c is used as the receiver of the suspension notification.

In step S413, the network interface controller 324 records the first virtual network address NID1 in the source address field of the suspension notification. In addition, the network interface controller 324 records the pause time parameter in the pause time field of the suspension notification.

As shown in FIG. 3, the first virtual network interface 324b may send a suspension notification recording the first virtual network address NID1 to the physical network interface 324a and other virtual network interfaces.

As shown in FIG. 3 and FIG. 4, in step S421, the second virtual network control interface receives the suspension notification. In step S422, the second virtual network control interface 324c may obtain the first virtual network address NID1 and the suspension time parameter from the content of the suspension notification. In step S423, the second virtual network control interface 324c activates the suspension mechanism of the first virtual network address NID1, the second virtual network control interface 324c suspends the packet to be transmitted to the first virtual network address NID1, and the time counter 324e starts to calculate the paused duration.

When the suspension mechanism of the first virtual network address NID1 being activated, the second virtual network control interface 324c finds all packets to be transmitted to the first virtual network address NID1, and executes step S424. In step S424, the second virtual network control interface 324c temporarily stores the packet to be transmitted to the first virtual network address NID1 into the packet waiting queue 324d. That is to say, when the suspension mechanism being activated, that is, before the paused duration reached the pause time parameter recorded in the suspension notification or before the second virtual network control interface 324c receives a resume notification (unsuspension notification), all packets to be transmitted to the first virtual network address NID1 would not be transmitted to the third virtual network address NID1 temporarily, but may be temporarily stored in the packet waiting queue 324d.

It should be noticed that although the second virtual network control interface 324c is shown in the embodiment of FIG. 4 to receive the suspension notification. In an embodiment, the physical network interface 324a in the network interface controller 324 and other virtual network interfaces (not shown in the figure) may all receive the suspension notification (or the resume notification) and perform packet flow control accordingly.

If in step S425, the network interface controller 324 determines that the paused duration has reached (or satisfied) the pause time parameter recorded in the suspension notification, then step S426 may be executed. In step S426, the physical network interface 324a cancels the suspension mechanism of the first virtual network address NID1.

After the suspension mechanism of the first virtual network address NID1 is canceled, step S427 is executed. In step S427, the network interface controller 324 may access the packet temporarily stored in the packet waiting queue 324d, and transmit the packet to the first virtual network interface 324b through the second virtual network interface 324c. It should be noted that, if necessary, the packet at this time may be temporarily stored in the first buffer BUF1 corresponding to the first virtual network interface 324b. In addition, since the second network interface controller 144 may suspend the packet transmitting to the first virtual network address NID1 during the period from step S423 to step S426, it may help to relieve the congestion situation of the first buffer BUF1 (for example, in step S412, it is found that the first buffer BUF1 has insufficient available space).

In step S416, the first virtual network interface 324b transmits the first packet to the first virtual machine VM1.

As shown in FIG. 4, after the first virtual network control interface 324b transmits the suspension notification, the first virtual network control interface 324b may execute step S414 to monitor whether the available space of the first buffer BUF1 is restored to be sufficient.

If the available space of the first buffer BUF1 is sufficient, step S415 is executed. In step S415, the first virtual network interface 324b generates a resume notification and transmits the resume notification to the second virtual network interface 324c. In step S415, the first virtual network interface 324b records the first virtual network address NID1 in the source address field of the resume notification, and the first virtual network interface 324b records a zero value in the pause time field of the resume notification. In other words, the resume notification is used to set the pause time of the first virtual network address NID1 to zero. When the second virtual network interface 324c receives the resume notification, the second virtual network interface 324c may also execute step S426 according to the resume notification, cancel the suspension mechanism of the first virtual network address NID1, and execute the subsequent step S427.

In addition, as shown in FIG. 3 and FIG. 4, in step S425, when the network interface controller 324 determines that the paused duration has not reached the pause time parameter recorded in the suspension notification, step S428 is executed. In step S428, the network interface controller 324 determines whether a resume notification is received (generated in step S415). If the resume notification is received, the process proceeds to step S426 to cancel the suspension mechanism of the first virtual network address NID1, and proceeds to step S427.

In this disclosure, the network interface controller 324 may generate pause frames for each virtual network interface and perform traffic pause independently, without affecting other de-paused network addresses, and would not stagnate the packet transmission of other virtual machines to due to the congestion of a single virtual machine.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A network communication system, comprising:
a first communication device, comprising:
a processor, configured to operate a first virtual machine; and
a first network interface controller, coupled to the processor, wherein the first network interface controller is configured to simulate a first virtual network interface having a first virtual network address, the first network interface controller comprises a first buffer for temporarily storing a packet to be transmitted to the first virtual machine, wherein in response to an available space in the first buffer being insufficient, the first network interface controller generates and transmits a pause frame corresponding to the first virtual network interface, the first network interface controller records the first virtual network address in a source address field of the pause frame; and
a second communication device, comprising:
a second network interface controller, communicatively connected to the first network interface controller, wherein when the second network interface controller receives the pause frame, the second network interface controller suspends the packet to be transmitted to the first virtual network address.

2. The network communication system of claim 1, wherein when the first network interface controller generates the pause frame, a pause time parameter corresponding to the first virtual network address is recorded in a pause time field of the pause frame.

3. The network communication system of claim 2, wherein the second network interface controller includes a time counter and a packet waiting queue, and the time counter calculates a paused duration based on the pause frame,
when the paused duration has not reached the pause time parameter, the second network interface controller temporarily stores the packet to be transmitted to the first virtual network address in the packet waiting queue,
when the paused duration reaches the pause time parameter, the second network interface controller transmits the packet which is corresponding to the first virtual network address and is temporarily stored in the packet waiting queue to the first virtual network interface of the first network interface controller.

4. The network communication system of claim 1, wherein the processor is further configured to operate a second virtual machine, and the first network interface controller is further configured to simulate a second virtual network interface having a second virtual network address, and the first network interface controller comprises a second buffer for temporarily storing another packet to be transmitted to the second virtual machine.

5. The network communication system of claim 4, wherein when the second network interface controller receives the pause frame and suspends the packet to be transmitted to the first virtual network address, the second network interface controller transmits the another packet to be transmitted to the second virtual network address to the second virtual network interface of the first network interface controller.

6. The network communication system of claim 4, wherein the first virtual network address and the second virtual network address are different media access control addresses.

7. The network communication system of claim 1, wherein the first network interface controller is configured to operate a physical network interface having a physical network address, wherein the first virtual network address and the physical network address are different media access control addresses.

8. The network communication system of claim 1, wherein in response to the available space in the first buffer being restored to be sufficient, the first network interface controller generates and transmits a deactivation flow control frame corresponding to the first virtual network interface, the first network interface controller records the first virtual network address in a source address field of the deactivation flow control frame, and the first network interface controller records a zero value in a pause time field of the deactivation flow control frame.

9. A communication device, comprising:
a processor, configured to operate a first virtual machine; and
a network interface controller, configured to operate a physical network interface having a physical network address, wherein the network interface controller is configured to simulate a first virtual network interface having a first virtual network address, and the network interface controller is configured to simulate a second virtual network interface having a second virtual network address, the network interface controller comprises a first buffer for temporarily storing a packet to be transmitted to the first virtual machine, wherein in response to an available space in the first buffer being insufficient, the first virtual network interface generates and transmits a suspension notification to the second virtual network interface or the physical network interface, and the first virtual network interface records the first virtual network address in a source address field of the suspension notification,
when the second virtual network interface or the physical network interface receives the suspension notification, the second virtual network interface or the physical network interface suspends the packet to be transmitted to the first virtual network address.

10. The communication device of claim 9, wherein when the network interface controller generates the suspension notification, a pause time parameter corresponding to the first virtual network address is recorded in a pause time field of the suspension notification.

11. The communication device of claim 10, wherein the network interface controller comprises a time counter and a packet waiting queue, and the time counter calculates a paused duration since the suspension notification is received,
when the paused duration has not reached the pause time parameter, the network interface controller temporarily stores the packet to be transmitted to the first virtual network address in the packet waiting queue,
when the paused duration reaches the pause time parameter, the network interface controller transmits the packet which is temporarily stored in the packet waiting queue and is corresponding to the first virtual network address to the first virtual network interface.

12. The communication device of claim 9, wherein the processor further operates a second virtual machine, and the second virtual network interface has the second virtual network address, the network interface controller comprises a second buffer for temporarily storing another packet to be transmitted to the second virtual machine.

13. The communication device of claim 12, wherein when the physical network interface receives the suspension notification and suspends the packet to be transmitted to the first virtual network address, the physical network interface transmits the another packet to be transmitted to the second virtual network address to the second virtual network interface.

14. The communication device of claim 12, wherein the first virtual network address and the second virtual network address are different media access control addresses.

15. The communication device of claim 9, wherein the first virtual network address and the physical network address are different media access control addresses.

16. The communication device of claim 9, wherein in response to the available space in the first buffer being restored to be sufficient, the network interface controller generates and transmits a resume notification corresponding to the first virtual network interface, the network interface controller records the first virtual network address in a source address field of the resume notification, and the network interface controller records a zero value in a pause time field of the resume notification.

17. A network communication method, comprising:
monitoring an available space of a first buffer on a first communication device, wherein the first buffer temporarily stores a packet to be transmitted to a first virtual machine on a first virtual network address;
when the available space of the first buffer is insufficient, by the first communication device, generating a pause frame corresponding to the first virtual network address and recording the first virtual network address in a source address field of the pause frame;
transmitting the pause frame to a second communication device by the first communication device; and
according to the pause frame which is received, by the second communication device, suspending the packet to be transmitted to the first virtual network address.

18. The network communication method of claim 17, further comprising:
when the first communication device generates the pause frame, recording a pause time parameter corresponding to the first virtual network address in a pause time field of the pause frame.

19. The network communication method of claim 18, wherein the second communication device comprises a time counter and a packet waiting queue, the time counter calculates a paused duration since receiving a suspension notification, and the network communication method further comprises:
when the paused duration has not reached the pause time parameter, temporarily storing the packet to be transmitted to the first virtual network address in the packet waiting queue, and
when the paused duration reaches the pause time parameter, transmitting the packet which is temporarily stored in the packet waiting queue and is corresponding to the first virtual network address to the first virtual network address.

20. The network communication method of claim 17, further comprising:
using the first communication device to monitor whether the available space of the first buffer is restored;
in response to the available space in the first buffer being restored to be sufficient, by the first communication device, generating a deactivation flow control frame, recording the first virtual network address in a source address field of the deactivation flow control frame, and recording a zero value in a pause time field of the deactivation flow control frame; and
transmitting the deactivation flow control frame to the second communication device by the first communication device.
